(19) United States
(12) Patent Application Publication
(10) Pub. No.: US 2014/0074636 A1
(43) Pub. Date: Mar. 13, 2014

(54) SELF-SERVICE TERMINAL DEVICE AND METHOD FOR COMMUNICATING WITH THE SELF-SERVICE TERMINAL DEVICE

(71) Applicants: TOSHIBA TEC KABUSHIKI KAISHA, Tokyo (JP); KABUSHIKI KAISHA TOSHIBA, Tokyo (JP)

(72) Inventors: Tomonori IKUMI, Shizuoka (JP); Naoki WATANABE, Tokyo (JP); Mika HIRAMA, Tokyo (JP); Masami TAKAHATA, Tokyo (JP)

(73) Assignees: TOSHIBA TEC KABUSHIKI KAISHA, Tokyo (JP); KABUSHIKI KAISHA TOSHIBA, Tokyo (JP)

(21) Appl. No.: 14/012,104

(22) Filed: Aug. 28, 2013

(30) Foreign Application Priority Data
Sep. 11, 2012 (JP) 2012-199022
Feb. 20, 2013 (JP) 2013-031158

(51) Int. Cl. G06Q 20/18

(52) U.S. Cl. CPC G06Q 20/18
USPC 705/21

(57) ABSTRACT

A method for communicating between a service terminal device and one or more user devices includes receiving from a user device a selection signal to select a content from contents of the service terminal device according to a first wireless communication standard, and transmitting the selected content from the service terminal device to the user device according to a second wireless communication standard when the user device is placed in close proximity to the service terminal device.

### CROSS-REFERENCE TO RELATED APPLICATION

The present application is based upon and claims the benefit of priorities from Japanese Patent Application No. 2012-199022 filed on Sep. 11, 2012 and Japanese Patent Application No. 2013-031158 filed on Feb. 20, 2013, the entire contents of both of which are hereby incorporated by reference.

### FIELD

Embodiments described herein relate to a technology carrying out a data communication between a self-service terminal apparatus and a user terminal.

### BACKGROUND

In recent years, as a way to send data stored in a user terminal such as a camera, a mobile phone, and the like, to an information processing apparatus at a high speed, a communication method according to a proximity wireless communication standard such as TransferJet® may be used. In this method, the user terminal is positioned at a place proximate to a communication section of the information processing apparatus (for example, positioned within 3 cm) and data is transferred from the user terminal to the information processing apparatus.

Another method for sending data stored in the user terminal to the information processing apparatus may combine the proximity wireless communication method with a wireless communication method according to an IEEE 802.1 standard (WiFi network or WLAN) or an IEEE 802.16 standard (for example, Wimax, 802.16e or Wibro).

### BRIEF DESCRIPTION OF THE DRAWINGS

FIG. 1 illustrates a schematic configuration of a self-service terminal apparatus according to one embodiment.

FIG. 2 is a block diagram illustrating a hardware configuration of a communication system including the self-service terminal apparatus according to the embodiment.

FIG. 3 illustrates an example in which content information is transmitted to user terminals carried by a plurality of users from the self-service terminal apparatus according to the embodiment.

FIG. 4 is a flowchart for transmitting the content information to a plurality of user terminals in the embodiment.

FIG. 5 is a flowchart for transmitting the content information to the user terminal when category information and the content information are selected in the self-service terminal apparatus according to the embodiment.

FIG. 6(a) illustrates a time needed to complete the selection and the transmission of the content information with respect to each user terminal communicating with a self-service terminal apparatus according to a comparative example.

FIG. 6(b) illustrates a time needed to complete the selection and the transmission of the content information with respect to each user terminal communicating with the self-service terminal apparatus according to the embodiment.

### DETAILED DESCRIPTION

In accordance with one embodiment, a method for communicating between a service terminal device and one or more user devices includes the steps of receiving from a user device a selection signal to select content from contents of the service terminal device according to a first wireless communication standard, and transmitting the selected content from the service terminal device to the user device according to a second wireless communication standard having a maximum transmission rate that is greater than a maximum transmission rate of the first wireless communication standard, when the user device is placed in close proximity to the service terminal device.

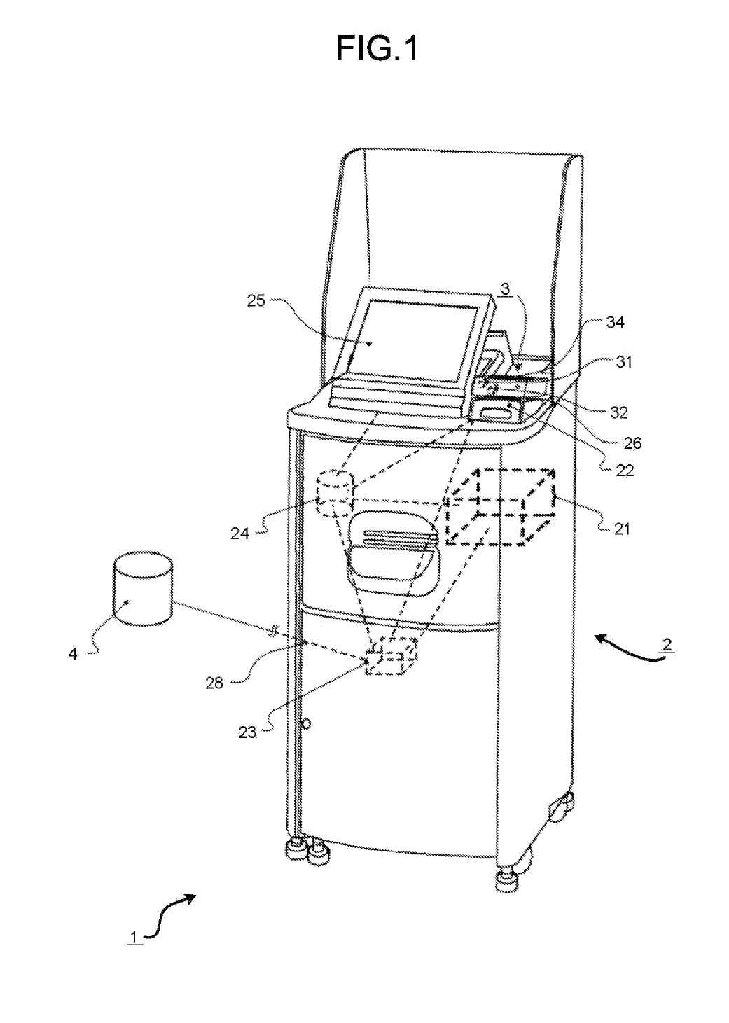

Hereinafter, a self-service terminal system 1 of the embodiment is described according to accompanying drawings. FIG. 1 illustrates a schematic configuration of the self-service terminal system 1 of the present embodiment.

As shown in FIG. 1, the self-service terminal system 1 of the present embodiment comprises a self-service terminal apparatus 2 and a user terminal 3.

The self-service terminal apparatus 2, as shown in FIG. 1, comprises a carrier section 26, a first wireless communication section 21, a first proximity wireless communication section 22, a first storage section 23, a first control section 24, and a first display section 25. The self-service terminal apparatus 2, in one example, is a kiosk terminal and the like provided in a street or a store such as a convenience store and the like for sending (transmitting) various kinds of entertainment content information (hereinafter, referred to as content information) classified into categories, such as a movie, music, and the like, to the user terminal 3. In addition, the self-service terminal apparatus 2 may be a terminal apparatus provided in a store, a device, a street, or the like, for a user expecting to acquire information or a user expecting to complete various procedures. As such, the self-service terminal apparatus 2 may be an apparatus provided in the a store and the like and operated by a customer, so as to carry out commodity retrieval or various procedures, and an apparatus provided in a station and operated by a user at the station, so as to display a guide map of the station or a peripheral guide map and the like. In addition, the self-service terminal apparatus 2 may be other apparatuses such as an apparatus arranged in a government office and the like for a user to operate to carry out various procedures and obtain a business form and the like, and an ATM apparatus provided in a bank and the like.

As shown in FIG. 1, the carrier section 26 is formed in the self-service terminal apparatus 2 on which the user terminal 3 can be placed. If the user terminal 3 is placed on the carrier section 26, the first control section 24 described below determines whether or not the user terminal 3 is positioned within a first communication range of the first proximity wireless communication section 22 described below.

The first proximity wireless communication section 22 carries out a proximity wireless communication with the user terminal 3 placed on the carrier section 26. The first proximity wireless communication section 22, for example, is a communication interface that operates according to a communication standard known as TransferJet®. Data transfer according to the TransferJet® standard is operated with a center frequency of 4.48 GHz, a maximum transmission rate of 560 Mbps (MAX)/a data throughput of 375 Mbps, and a communication range of within 3 cm. In addition, if the first proximity wireless communication section 22 recognizes the user terminal 3, a communication with the user terminal 3 is automatically started according to the TransferJet® standard.

The first proximity wireless communication section 22 comprises a first proximity wireless interface (a first I/F, for short) 221 controlled by the first control section 24 that is carrying out the overall control of the self-service terminal apparatus 2, and a first antenna section 222 serving as a sending and receiving antenna of the first I/F 221. The first antenna section 222 is arranged in the carrier section 26.

The first wireless communication section 21, as shown in FIG. 1, is disposed inside the self-service terminal apparatus 2, and carries out a wireless communication at a communication speed slower than that of the proximity wireless communication section 22 with the user terminal 3 which is positioned within a second communication range that is wider than the first communication range. The first wireless communication section 21, for example, is a communication section using a wireless network (WiFi network or WLAN) according to an IEEE 802.11 standard or a wireless communication network according to an IEEE 802.16 standard (for example, Wimax, 802.16e or Wibro), and the like, to carry out the communication. Unlike the first proximity wireless communication section 22, the first wireless communication section 21 can carry out a communication with a user terminal 3 that is positioned outside the first communication range. In addition, in order to carry out a wireless communication between the user terminal 3 and the self-service terminal apparatus 2, the first wireless communication section 21 carries out an initial authentication procedure (e.g., verification procedure of an ID or a password input from the user terminal 3) to carry out a communication with the user terminal 3 having the verified connection ID acquired by initial authentication. Therefore, when there is a plurality of user terminals 3, each of which has a verified connection ID, the first wireless communication section 21 can simultaneously carry out a communication with the plurality of user terminals 3.

The first storage section 23, as shown in FIG. 1, is connected with the first wireless communication section 21 and the first proximity wireless communication section 22, and may be implemented as a memory, an HDD (Hard Disk Drive), or the like. In the first storage section 23 arranged inside the self-service terminal apparatus 2, multiple pieces of category information, information related to the headline list of the category information (category headline list information), multiple pieces of content information categorized based on the category information, and information related to the headline list of the multiple pieces of content information (content headline list information), are stored. In addition, the first storage section 23 is connected with a cloud service group 4 (server) storing various contents. When the selected content information acquired by the first control section 24 described below is not stored in the first storage section 23, the first storage section 23 acquires the selected content information from the cloud service group 4 and stores it therein. In addition, the cloud service group 4 is an apparatus including a plurality of cloud computers (not shown), and in each cloud computer, various kinds of content information such as works of movie, music, or the like are stored.

The first control section 24, for example, is a CPU, and controls processing of the overall self-service terminal apparatus 2. If a user terminal 3 is positioned within the second communication range, the first control section 24 receives the content selection information corresponding to a content information selected by a user from the multiple pieces of content information originally stored in the first storage section 23 or the cloud service group 4, from the user terminal 3 through the first wireless communication section 21. In addition, after the content selection information is received from the user terminal 3, if the user terminal 3 is positioned within the first communication range, the first control section 24 transmits the content information corresponding to the content selection information to the user terminal 3 through the proximity wireless communication section 22.

Herein, the content selection information received from the user terminal 3 may be information corresponding to a content selected by the user from the content headline list information listing the multiple pieces of content information stored in the first storage section 23 and the cloud service group 4. In this case, the content headline list information is transmitted to a user terminal 3 in the second communication range through the first wireless communication section 21 based on a control by the first control section 24.

In addition, the content selection information received from the user terminal 3 may be information selected by the user in the content headline list information listing the multiple pieces of content information in a category corresponding to category selection information. In this case, category headline list information is transmitted to the user terminal 3 positioned within the second communication range through the first wireless communication section 21 based on a control by the first control section 24, and then the category selection information, i.e., information corresponding to a category selected by the user from the category headline list information, is received from the user terminal 3 in the second communication range. The category headline list information is information related to the headline list of the multiple pieces of category information stored in the first storage section 23 and the cloud service group 4.

The first display section 25, as shown in FIG. 1, is a touch panel display and accepts various operations from a user. The first display section 25 is a display section displaying information to the user according to an output from the first control section 24. In addition, the first display section 25 displays the multiple pieces of category information, the category headline list information, the multiple pieces of content information belonging to each piece of category information, and the content headline list information, which are stored in the first storage section 23 and the cloud service group 4. If information indicating that the transmission preparation of the content information is completed is received from the first control section 24, the first display section 25 displays that the self-service terminal apparatus 2 completes the transmission preparation of the content information to the user terminal 3.

The user terminal 3 comprises a second wireless communication section 31 carrying out a wireless communication with the first wireless communication section 21, a second proximity wireless communication section 32 carrying out a proximity wireless communication with the first proximity wireless communication section 22, an operation section 33 accepting various operation inputs from the user, and a second display section 34 displaying various kinds of information to the user. The user terminal 3, for example, may be a notebook personal computer, a tablet personal computer, a mobile phone, a PHS, a smart mobile phone, a smart book, a slate terminal, a camera, and the like.

The second wireless communication section 31, for example, is a communication section carrying out a communication using the wireless network (WiFi network or WLAN) according to the IEEE 802.11 standard or the wireless communication network according to the IEEE 802.16 standard (for example, Wimax, 802.16e or Wibro), and the like. As it has a configuration the same as that of the first wireless communication section 21, the descriptions are omitted.

The second proximity wireless communication section 32 is a communication interface operating a communication according to the TransferJet® communication standard. As it has a same configuration as that of the first proximity wireless communication section 22, the descriptions are omitted.

The second proximity wireless communication section 32 has a second proximity wireless interface (second I/F) 321 carrying out a wireless communication with the first I/F 221, and a second antenna section 322 serving as a sending and receiving antenna of the second I/F 321.

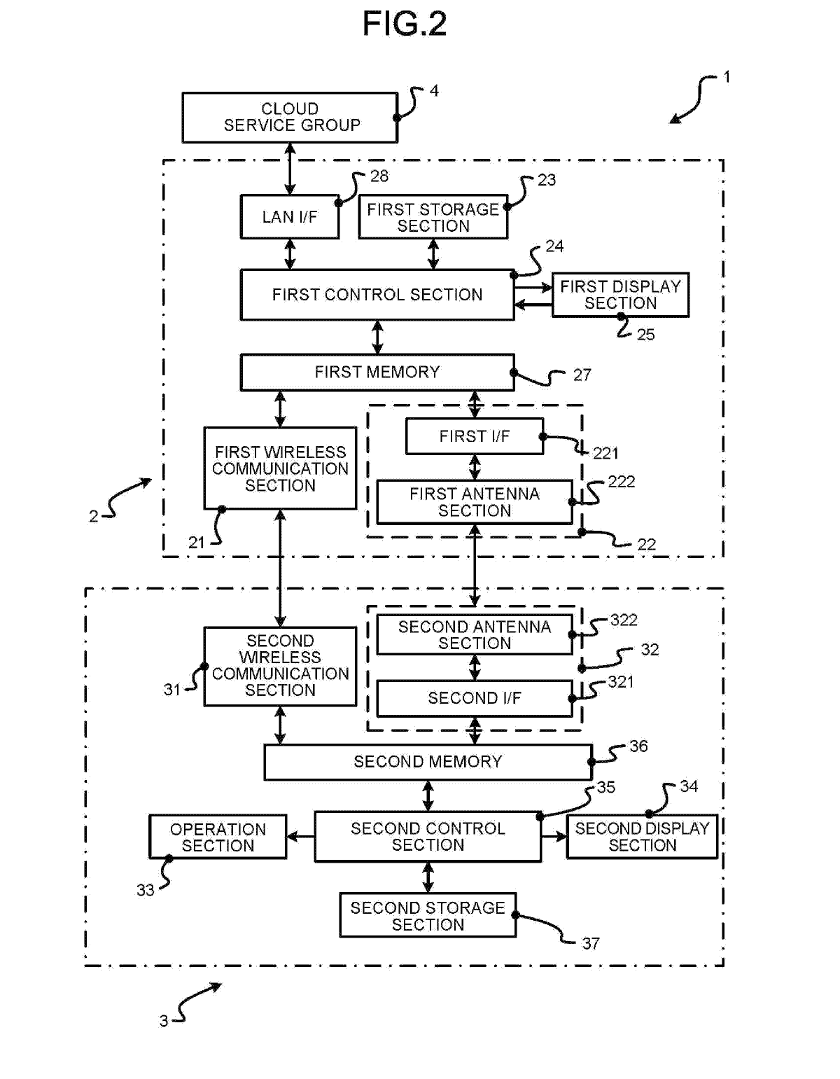

Subsequently, a hardware configuration of the self-service terminal system 1 is described. FIG. 2 is a block diagram illustrating the hardware configuration of the self-service terminal system 1 according to the embodiment.

The self-service terminal apparatus 2 comprises the first control section 24, the first wireless communication section 21, the first proximity wireless communication section 22, a first memory 27, the first storage section 23, and a LAN I/F 28. The first proximity wireless communication section 22 includes the first I/F 221 and the first antenna section 222.

The first memory 27 temporarily stores the category information, the category headline list information, the content information, the content headline list information, the category selection information, and the content selection information, which are transmitted through the first wireless communication section 21 or the first proximity wireless communication section 22.

The LAN I/F 28 is an interface for a wired network, and is a connection between the first storage section 23 and the cloud service group 4. When the selected content information received by the first wireless communication section 21 is not stored in the first storage section 23, the first control section 24 requests the selected content information to the cloud service group 4. Through the LAN I/F 28 Moreover, the first control section 24 causes the selected content information to be transmitted to the first storage section 23 from the cloud service group 4 through the LAN I/F 28, controls the first control section 24 to store it, and controls the first wireless communication section 21 to transmit the selected content information to the user terminal 3.

The user terminal 3 comprises a second control section 35, a second memory 36, a second storage section 37, the second wireless communication section 31, the second proximity wireless communication section 32, the operation section 33, and the second display section 34. The second proximity wireless communication section 32 includes the second I/F 321 and the second antenna section 322.

The second control section 35 is a CPU, and controls the overall processing of the user terminal 3. The second control section 35 controls the second display section 34 to display information according to the operation input into the operation section 33 by the user. In addition, the second control section 35 controls the second wireless communication section 31 and the second I/F 321 to receive the transmitted category information, the category headline list information, the content information, the content headline list information, the category selection information, and the content selection information, and controls the second storage section 37 to store them therein.

The second memory 36 temporarily stores the category information, the category headline list information, the content information, the content headline list information, the category selection information and the content selection information, which are sent and received through the second wireless communication section 31 and the second proximity wireless communication section 32.

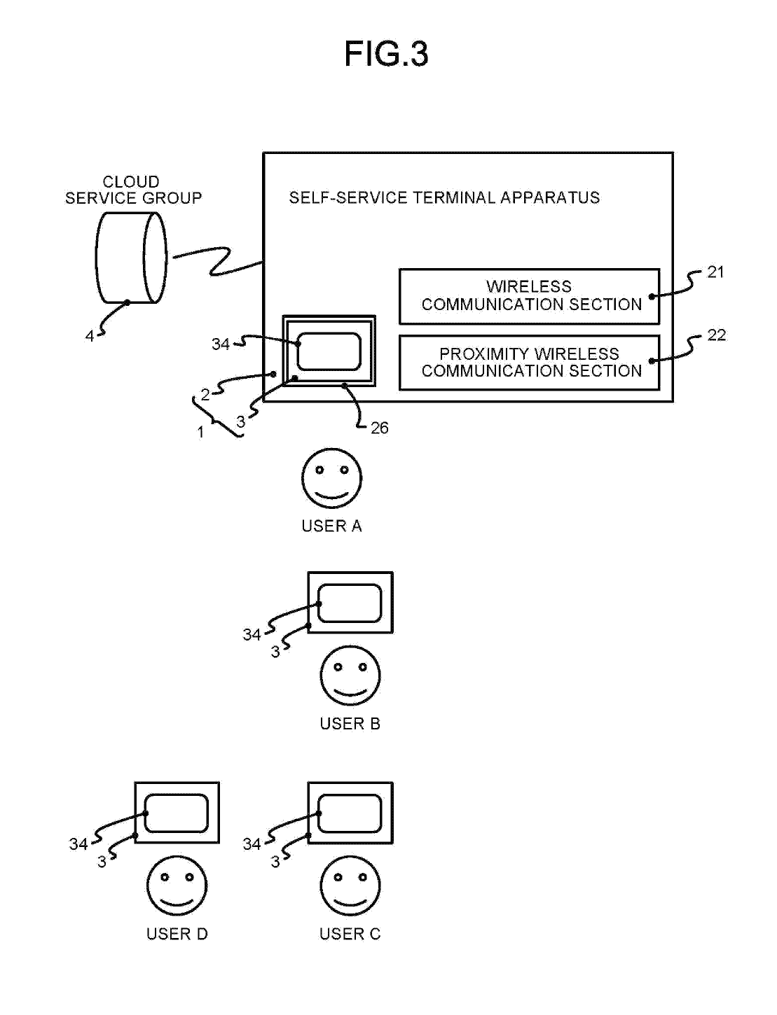

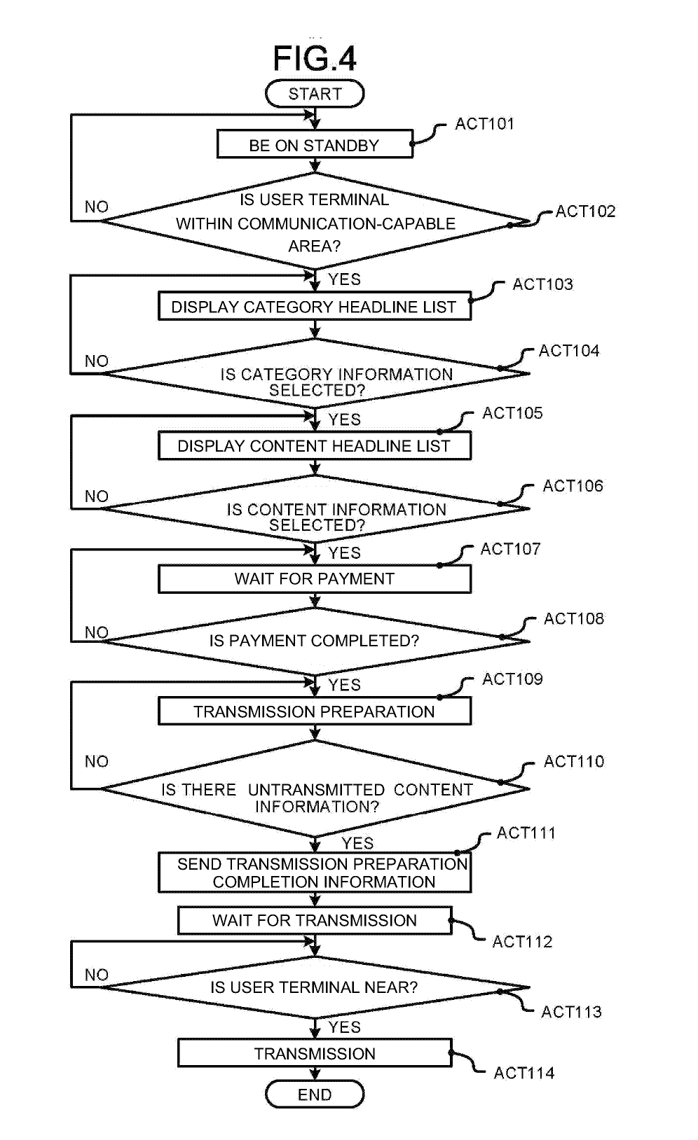

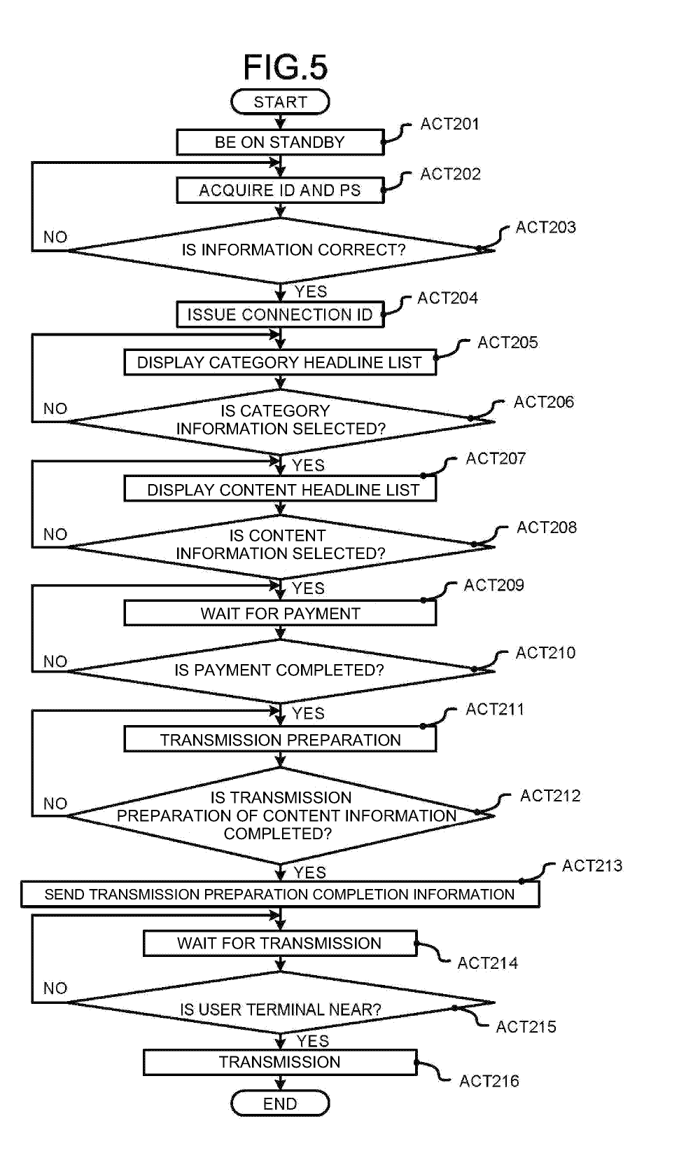

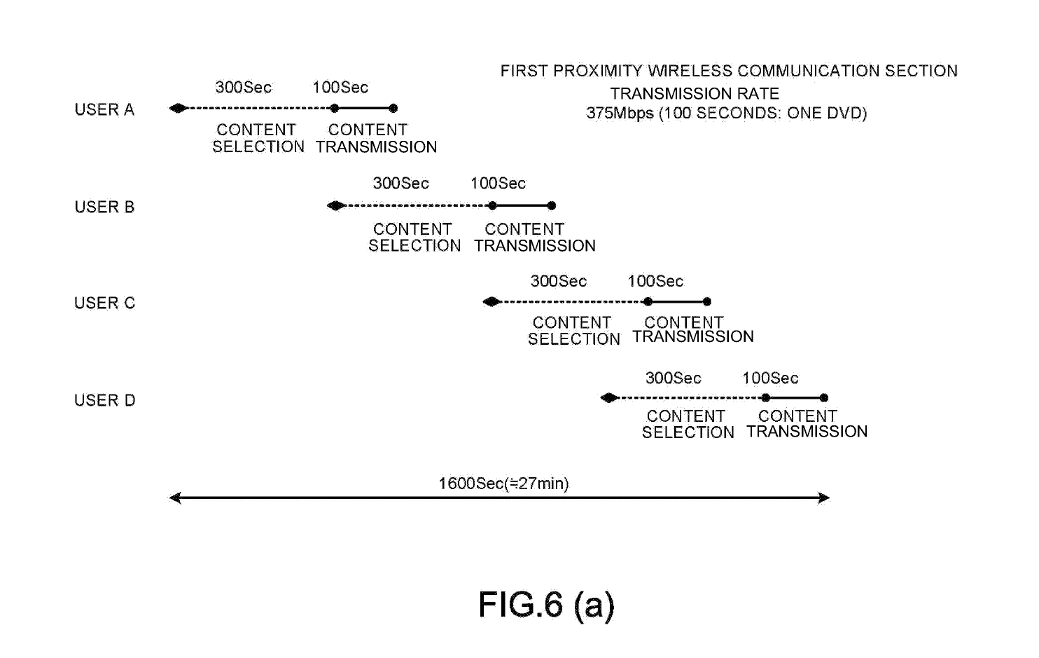

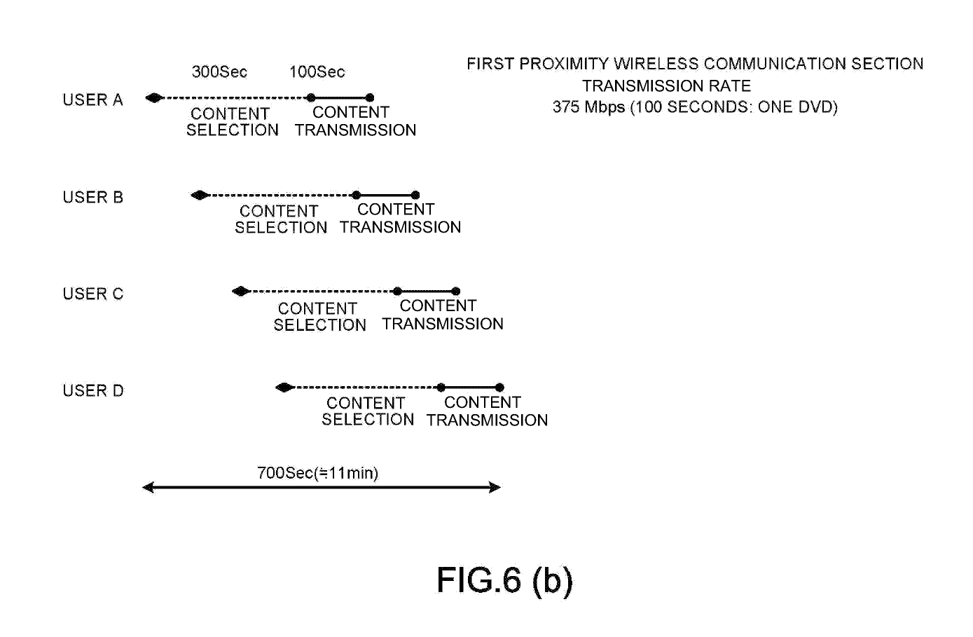

Next, a content communication method based on the self-service terminal system 1 of the present embodiment is described. FIG. 3 illustrates an example in which the content information is transmitted to the user terminals 3 carried by a plurality of users in the embodiment. FIG. 4 is a flowchart for transmitting the content information to the plurality of user terminals 3 in the embodiment. FIG. 5 is a flowchart for transmitting the content information to the user terminal 3 when the category information and the content information are selected in the self-service terminal apparatus 2 of the embodiment. FIG. 6(a) illustrates a time needed to complete the selection and the transmission of the content information with respect to each user terminal communicating with a self-service terminal apparatus according to a comparative example. FIG. 6(b) illustrates a time needed to complete the selection and the transmission of the content information with respect to each user terminal communicating with the self-service terminal apparatus 2 according to the embodiment.

As shown in FIG. 3, user A is using the self-service terminal apparatus 2, and user B, user C, and user D are standing in a line behind the user A. The transmitting operation of the content information to each user terminal respectively carried by the users A, B, C, and D is described.

First, the control of sending the content information in the self-service terminal apparatus 2 to the user terminal 3 of the user A is described with reference to FIG. 4.

The first control section 24 is on standby for a specified time period (ACT101). The user A puts his own user terminal 3 on the carrier section 26 of the self-service terminal apparatus 2. The first control section 24 determines whether or not the user terminal 3 is located within the communication-capable range (e.g., the first communication range) of the first proximity wireless communication section (ACT102). If the user terminal 3 is determined to be located within the communication-capable range of the first proximity wireless communication section 22 (Yes in ACT102), the first control section 24, for example, controls the first display section 25, such as a touch panel and the like, to display the category headline list information stored in the first storage section 23 (ACT103). The first control section 24 determines whether or not a category information is selected from the category headline list information displayed on the first display section 25 by the user operating the first display section 25 (ACT104). If a category information is determined to be selected (Yes in ACT104), the first control section 24 acquires the category selection information corresponding to the selected category, and controls the first display section 25 to display the content headline list information belonging to the category corresponding to the category selection information (ACT105). The first control section 24 determines whether or not the content information is selected from the content headline list information displayed on the first display section 25 by the user operating the first display section 25 (ACT106).

If a content information is determined to be selected (Yes in ACT106), the first control section 24 acquires the content selection information corresponding to the selected category, and controls the first display section 25 to display various payment procedures such as a cost needed for transmitting the selected content information to the user terminal 3 or a payment method and the like (ACT107). The first control section 24 determines whether or not the various payment procedures are completed (ACT108). If the various payment procedures are determined to be completed (Yes in ACT108), the first control section 24 transfers the content information corresponding to the content selection information and stored in the first storage section 23 to the first memory 27, and carries out the transmission preparation to the user terminal 3 (ACT109). The first control section 24 determines whether or not the transmission preparation of the content information to the first memory 27 is completed (ACT110). If the transmission preparation of the content information to the first memory 27 is determined to be completed (Yes in ACT110), the first control section 24 causes transmission preparation completion information to be sent to the user terminal 3 through the first wireless communication section 21 (ACT111). The first control section 24 is on standby for the specified time period for transmitting the content information (ACT112). If the second control section 35 receives the transmission preparation completion information through the second wireless communication section 31, the second control section 35 controls the second display section 34 to display that the transmission preparation is completed, and sets the user terminal 3 in a receivable state so that the user terminal 3 is capable of receiving the content information from the self-service terminal apparatus 2.

After being on standby for the specified time period in ACT112, the first control section 24 determines whether or not a reply is accepted through the first wireless communication section 21, and determines whether or not the user terminal 3 is in the receivable state based on the reply (ACT113). If the first control section 24 determines that the user terminal 3 is in the receivable state (Yes in ACT113), the first control section 24 controls the first proximity wireless communication section 22 to transmit the content information transferred to the first memory 27 to the user terminal 3 (ACT114). In addition, when the first proximity wireless communication section 22 operates according to the TransferJet® standard, and when the first control section determines that the first proximity wireless communication section 22 and the second proximity wireless communication section 32 are positioned within a specific range, the confirmation processing of the user A is not carried out, and the content sending is automatically started.

Next, the control related to a transmission of the content information to the user terminal 3 carried by the user B is described with reference to FIG. 5.

As shown in FIG. 3, the user B is standing in a line behind the user A, and cannot directly operate the self-service terminal apparatus 2 unlike the user A. Therefore, the selection procedure and the payment procedure related to the category information and the content information are carried out by the user terminal 3.

The first control section 24 waits for a request from the user terminal 3 carried by the user B (which is a user terminal different from the user terminal positioned in the carrier section 26) through the first wireless communication section 21 (ACT 201). The first control section 24 requests and acquires the input of the ID and the password of the user B from the user terminal 3 carried by the user B through the first wireless communication section 21 (ACT 202). The first control section 24 determines whether or not the acquired ID and password are the connection ID and password which can access the self-service terminal apparatus 2 (ACT203). If the acquired ID and password are determined not to be the connection ID and password which can access the self-service terminal apparatus 2 (No in ACT203), the first control section 24 returns to the processing of ACT202. If the first control section 24 determines that the acquired ID and password are the connection ID and password which can access the self-service terminal apparatus 2 (Yes in ACT203), the first control section 24 sends the connection ID to the user terminal 3, and starts a communication with the user terminal 3 through the first wireless communication section 21 (ACT204).

The first control section 24 causes the category headline list information stored in the first storage section 23 to be sent to the user terminal 3 in a second state and controls the second display section 34 to display it (ACT205). The user B operates the second display section 34, and selects category information from the category headline list information displayed on the second display section 34. The first control section 24 determines whether or not category information is selected by user B (ACT206). If category information is determined not to be selected (No in ACT206), the first control section 24 returns to the processing of ACT205. If category information is determined to be selected (Yes in ACT206), the first control section 24 acquires the category selection information corresponding to the category selected by the user B, and controls the second display section 34 to display the content headline list information belonging to the category selection information (ACT207). The user B operates the second display section 34, and selects content information from the content headline list information displayed on the second display section 34. The first control section 24 determines whether or not content information is selected by the user B (ACT208). If content information is determined not be selected (No in ACT208), the first control section 24 returns to the processing of ACT207.

If the first control section 24 determines that content information is selected (Yes in ACT208), the first control section 24 controls the first wireless communication section 21 to acquire the content selection information corresponding to the content selected by the user B, controls the second display section 34 to display the information related to the various payment procedures such as the cost needed for transmitting the selected content information to the user terminal 3 or the payment method and the like, and waits for a specified time period (ACT209). The first control section 24 receives the information from the user terminal 3 of the user B through the first wireless communication section 21, and determines whether or not the received information is the completion information of the various procedures (ACT210). If it is determined not to be the completion information of various payment procedures (No in ACT210), the first control section 24 returns to the processing of ACT209.

If the first control section 24 determines that all the information related to the various payment procedures is acquired, namely, it is the completion information of the various payment procedures (Yes in ACT210), the first control section 24 transfers the content information corresponding to the content selection information and stored in the first storage section 23 to the first memory 27, and carries out the transmission preparation to the user terminal 3 (ACT211). If the first control section 24 determines that the transmission of the content information to the first memory 27 is completed (Yes in ACT212), the first control section 24 sends the transmission preparation completion information (information indicating that the transmission preparation of the content information is completed) to the user terminal through the first wireless communication section 21 (ACT213). If the second control section 35 receives the transmission preparation completion information through the second wireless communication section 31, the second control section 35 controls the second display section 34 to display that the transmission preparation is completed, and controls the user terminal 3 to be in the receivable state.

Moreover, after the user A completes the operation in the self-service terminal apparatus 2, the user B places his own user terminal 3 on the carrier section 26. After the specified time period for the processing of ACT213, the first control section 24 determines whether or not the user terminal 3 of the user B in the receivable state is located in the communication range of the first proximity wireless communication section 22 (ACT215). If the user terminal 3 of the user B in the receivable state is determined to be located in the communication range of the first proximity wireless communication section 22 (Yes in ACT215), the first control section 24 controls the first proximity wireless communication section 22 to transmit the content information to the user terminal 3 of the user B (ACT216).

The process for transmitting the content information to each user terminal 3 of the user C and the user D from the self-service terminal apparatus 2 is the same as that for the user terminal 3 carried by the user B, and includes the connection ID issuing processes (ACT200-ACT204), the selection processes (ACT205, ACT206) of the category information, the selection actions (ACT207, ACT208) of the content information, payment processes (ACT209, ACT210), the transmission preparation processes (ACT211-ACT213, ACT220, ACT221) of the content information, and the transmission processes (ACT214-ACT217) of the content information. Therefore, the descriptions are omitted. Herein, so long as the user terminals 3 of the user C and the user Dare located in the communication-capable range, even while the user terminal 3 of the user B is communicating with the self-service terminal apparatus 2, the first wireless communication section 21 of the self-service terminal apparatus 2 can simultaneously communicate with the user terminal 3 of the user C and the user terminal 3 of the user D respectively.

In this way, by using the first wireless communication section 21 disposed in the self-service terminal apparatus 2, while the user A is operating the selection procedure of the category information, the selection procedure of the content information, and the payment procedure and the transmission procedure of the content information, from the self-service terminal apparatus 2 on the self-service terminal apparatus 2, the self-service terminal apparatus 2 can also communicate with each user terminal 3 of the user B, the user C, and the user D, standing in line behind the user A, and completes the selection procedure of the category information, the selection procedure of the content information, and the payment procedure from the user B, the user C, and the user D. Namely, by using the self-service terminal apparatus 2 of the present embodiment, the user B, the user C, and the user D need to operate the self-service terminal apparatus 2, only to receive the content information from the self-service terminal apparatus 2. Thus, the time for which the user B, the user C, and the user D occupy the self-service terminal apparatus 2 can be shortened. Moreover, the time for which the user A, the user B, the user C, and the user D use the self-service terminal apparatus 2 can be also shortened.

In order to describe the effect mentioned above more specifically, the comparative example in which a self-service terminal apparatus only comprises the proximity wireless communication section is compared with the self-service terminal apparatus 2 of the present embodiment for description. Herein, the total time to select the category information, the content information, and to complete the payment with respect to each user is assumed to be 300 seconds, and a transmission time to transmit the content information from the self-service terminal apparatus 2 to the user terminal 3 is assumed to be 100 seconds. In addition, the communication speed of the first proximity wireless communication section is assumed to be 375 Mbps, and transmitted data size is assumed to be equal to the data size of one DVD.

As shown in FIG. 6(a), in the comparative example, in the state of placing the user terminal 3 on the carrier section 26, each user has to operate the self-service terminal apparatus 2, and carry out the selection procedure of the category information, the selection procedure of the content information, the payment procedure, and the transmission procedure of the content information. Further, in order to transmit the content information requested by each user to each user terminal 3 of the user A, the user B, the user C, and the user D, each user needs to spend 400 seconds in total. Therefore, in order to complete the transmission of the content information to each user terminal 3 of the user A, the user B, the user C, and the user D from the self-service terminal apparatus of the comparative example, 1600 seconds (26 minutes and forty seconds) in total are needed.

To the contrary, the self-service terminal apparatus 2 of the present embodiment, as shown in FIG. 6(b), can complete the selection procedure of the category information, the selection procedure of the content information, and the payment procedure of the user B, the user C, and the user D while carrying out the selection procedure of the category information, the selection procedure of the content information, the payment procedure and the transmission procedure of the content information of the user A. Therefore, the time for which the user B, the user C, and the user D operate the self-service terminal apparatus 2 can be reduced to only 100 seconds needed for the content transmission procedure. Therefore, in the self-service terminal apparatus 2 of the present embodiment, in order to complete the transmission of the content information to each user terminal 3 of the user A, the user B, the user C, and the user D, only 700 seconds (11 minutes and forty seconds) in total are needed. Namely, with the self-service terminal apparatus 2 of the present embodiment, the time needed to complete the transmission of the requested content information to each user terminal 3 by four users is shorter and is less than half of the time needed to complete the transmission with the self-service terminal apparatus of the comparative example. According to the embodiment, compared with the self-service terminal apparatus of the comparative example, the self-service terminal apparatus 2 of the present embodiment can shorten the waiting time of the users when used by a lot of users.

In addition, if the preparation of transmitting the content information requested by the user is completed in the self-service terminal apparatus 2, the self-service terminal system 1 of the present embodiment sends the transmission preparation completion information to the user terminal 3, and displays that the transmission preparation is completed on the second display section 34 of the user terminal 3. Consequently, which user's terminal is going to receive the requested content information can be recognized clearly. Namely, even though an order in a line in which the users are waiting to use the self-service terminal apparatus 2 is changed, the user himself can also recognize the order of acquiring the content information from the self-service terminal apparatus 2 by looking at the display of his or her own user terminal 3.

In addition, the content information is transmitted from the self-service terminal apparatus 2 only to the user terminal 3 that has completed the selection procedure of the selected content information and the various payment procedures and is in the receivable state in the self-service terminal system 1 of the present embodiment. Thus, the system can also prevent wrongly transmitting the content information from the self-service terminal apparatus 2 to the user terminal 3 carried by a user who has not completed the selection procedure and the various payment procedures, even if the user wrongly places the user terminal 3 on the carrier section 26.

In the disclosed embodiments, processing can be accomplished by a computer-executable program, and this program can be realized in a computer-readable memory device. In the disclosed embodiments, a memory device, such as a magnetic disk, a flexible disk, a hard disk, an optical disk (CD-ROM, CD-R, DVD, and so on), an optical magnetic disk (MD and so on), can be used to store instructions for causing a processor or a computer to perform the processes described above. Furthermore, based on an instruction of the program installed from the memory device to the computer, OS (operation system) operating on the computer, or MW (middleware software), such as database management software or network, may execute one part of each processing to realize the embodiments.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A method for communicating between a service terminal device and one or more user devices that are connected wirelessly according to a first wireless communication standard having a first communication range, the method comprising:
receiving from a user device a selection signal to select a content from contents of the service terminal device; and
transmitting the selected content according to a second wireless communication standard having a maximum transmission rate that is greater than a maximum transmission rate of the first wireless communication standard and a second communication range that is shorter than the first communication range.

2. The method according to claim 1, wherein
the selection signal is received according to the first wireless communication standard.

3. The method according to claim 2, wherein
the selection signal is received from the user device, when the user device is located outside the second communication range.

4. The method according to claim 1, wherein
the selection signal is received from the user device at a rate slower than a rate at which the content is transmitted from the service terminal to the user device.

5. The method according to claim 1, wherein
the first wireless communication standard is a wireless communication according to an IEEE 802.1 standard or an IEEE 802.16 standard, and the second wireless communication standard is the TransferJet® wireless communication standard.

6. The method according to claim 1, further comprising:
transmitting from the service terminal device to the user device standby information indicating that the selected content is ready to be transmitted before the selected content is transmitted, when the user device is located within the first communication range and outside the second communication range.

7. The method according to claim 1, further comprising:
transmitting from the service terminal device to the user device a list of content identification information including the content identification information of the selected content, when the user device is located within the first communication range and outside the second communication range.

8. The method according to claim 1, further comprising:
receiving one or more selection signals from one or more of the other user devices while the selected content is transmitted from the service terminal device to the user device.

9. A service terminal device configured to communicate with plural user devices according to a first wireless communication standard having a first communication range, comprising:
a communication unit configured to receive from a user device a selection signal to select a content from contents of the service terminal and to transmit the selected content according to a second wireless communication standard having a maximum transmission rate that is greater than a maximum transmission rate of the first wireless communication standard and a second communication range that is shorter than the first communication range; and
a control unit configured to control the communication unit to transmit the selected content when the user device is located within the second communication range from the communication unit.

10. The service terminal device according to claim 9, wherein
the communication unit includes a first subunit configured to receive the selection signal and a second subunit configured to transmit the selected content, and
the first subunit is configured to receive the selection signal from the user device, when the user device is located within the first communication range.

11. The service terminal device according to claim 10, wherein the first wireless communication standard is a wireless communication according to an IEEE 802.1 standard or an IEEE 802.16 standard, and the second wireless communication standard is the TransferJet® wireless communication standard.

12. The service terminal device according to claim 10, wherein
the first subunit is configured to transmit to the user device standby information indicating that the selected content is ready to be transmitted, and
the control unit is configured to control the first subunit to transmit the standby information when the user device is located within the first communication range, before the second subunit transmits the selected content when the user device is located within the second communication range.

13. The service terminal device according to claim 10, wherein the control unit is configured to control the first subunit to transmit to the user device a list of content identification information including the content identification information of the selected content, when the user device is located within the first communication range.

14. The service terminal device according to claim 10, wherein the first subunit is configured to receive selection signals from one or more of the other user devices while the second subunit transmits the selected content to the user device.

15. A communication system comprising:
one or more user devices and a service terminal device configured to communicate wirelessly with the user devices, the service terminal device including
a communication unit configured to receive from a user device a selection signal to select a content from contents of the service terminal device and to transmit the selected content to the user device; and
a control unit configured to control the communication unit to receive from the user device the selection signal according to a first wireless communication standard having a first communication range and transmit the selected content according to a second wireless communication standard having a second communication range that is shorter than the first communication range.

16. The communication system according to claim 15, wherein
the communication unit includes a first subunit operating according to the first wireless communication standard and configured to receive the selection signal, and a second subunit operating according to the second wireless communication standard and configured to transmit the selected content.

17. The communication system according to claim 16, wherein
the first wireless communication standard has a maximum transmission rate that is slower than the second wireless communication standard.

18. The communication system according to claim 16, wherein the first wireless communication standard is a wireless communication according to an IEEE 802.1 standard or an IEEE 802.16 standard, and the second wireless communication standard is the TransferJet® wireless communication standard.

19. The communication system according to claim 16, wherein the control unit is configured to control the first subunit to transmit to the user device a list of content identification information including the content identification information of the selected content, when the user device is located within the first communication range.

20. The communication system according to claim 15, wherein the first subunit is configured to receive selection signals from one or more of the other user devices while the second subunit transmits the selected content to the user device.
